(19) United States
(12) Patent Application Publication
(10) Pub. No.: US 2012/0039697 A1
(43) Pub. Date: Feb. 16, 2012

(54) ROBOTIC ARM

(75) Inventors: JIAN-PING JIN, Shenzhen (CN); LI-HUA ZHANG, Shenzhen (CN); KE ZHOU, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/913,934

(22) Filed: Oct. 28, 2010

(30) Foreign Application Priority Data
Aug. 16, 2010 (CN) 201010254235.5

(51) Int. Cl. B25J 11/00; B25J 18/00; B25J 15/06

(52) U.S. Cl. 414/737; 901/40; 901/27

(57) ABSTRACT

A robotic arm is for holding a molded item. The robotic arm includes a mount; a suction cup assembly r for holding the molded item; and a rotating assembly mounted between the mount and the suction cup assembly to adjust the angle between the suction cup assembly and to the mount.

### CROSS-REFERENCE TO RELATED APPLICATIONS

This application is related to co-pending U.S. patent applications (Attorney Docket No. US34531 and US 34532), entitled “ROBOTIC ARM”, by Jin et al. These application have the same assignee as the present application and have been concurrently filed herewith. The above-identified applications are incorporated herein by reference.

### BACKGROUND

1. Technical Field

This disclosure relates to robotic arms, particularly to robotic arms for robotic arm handling freshly molded items.

2. Description of Related Art

Molding machines typically use robotic arms to handle molded items. However, typical robotic arms have a complicated mechanism and are difficult to adjust.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary robotic arm. Moreover, in the drawings like reference numerals designate corresponding parts throughout the several views. Wherever possible, the same reference numbers are used throughout the drawings to refer to the same or like elements of an embodiment.

FIG. 1 is an assembled view of an exemplary embodiment of a robotic arm.

FIG. 2 is another assembled view of the robotic arm shown in FIG. 1.

FIG. 3 is an exploded view of the robotic arm shown in FIG. 1.

FIG. 4 is another exploded view of the robotic arm shown in FIG. 1.

### DETAILED DESCRIPTION

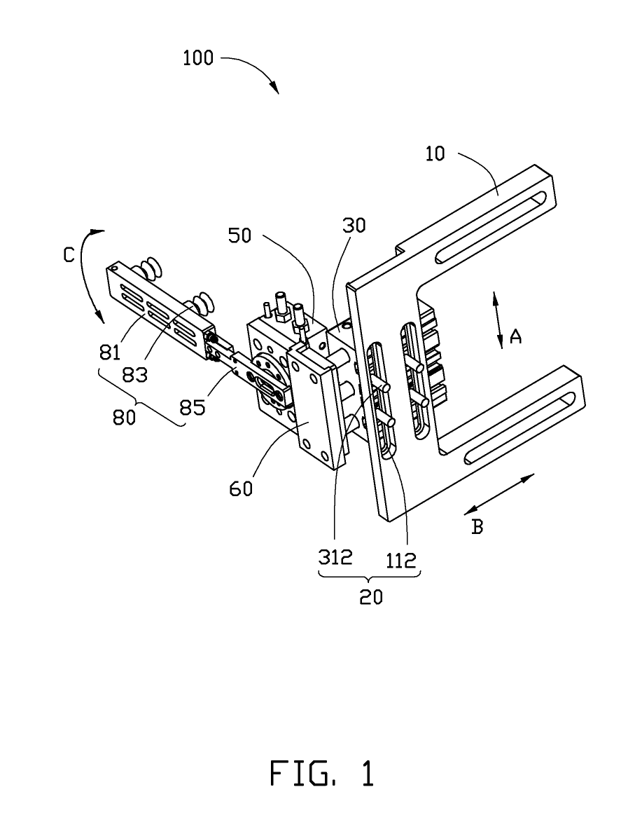

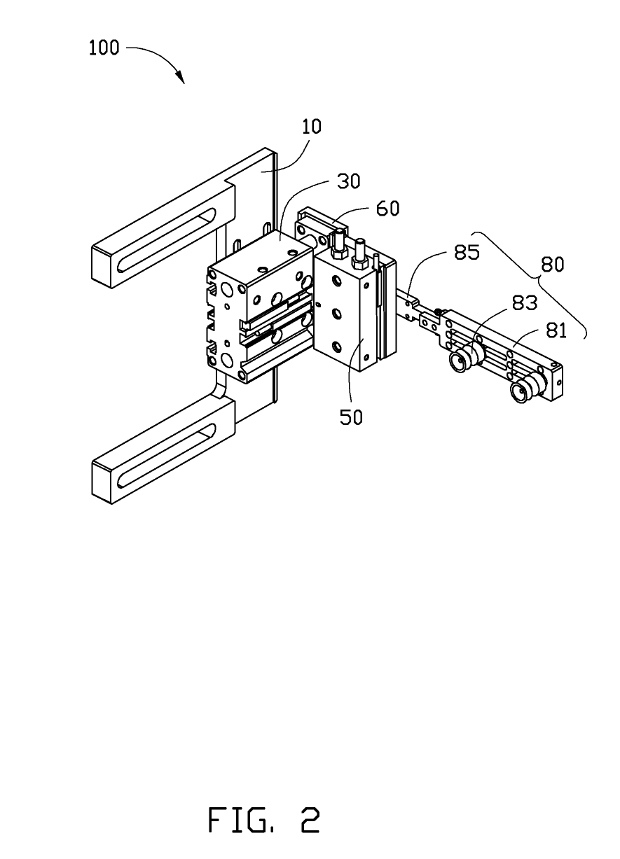

Referring to FIGS. 1-2, an exemplary robotic arm 100 used in a molding machine (not shown) is disclosed. The robotic arm 100 can insert into the molding machine for holding and removing molded items (not shown) in the molding machine.

The robotic arm 100 includes a mount 10, a lifting device 20, a horizontal driving device 30, a rotating assembly 50, a connecting board 60 and a suction cup assembly 80. The lifting device 20 is mounted between the mount 10 and the horizontal driving device 30. The lifting device 20 is for the horizontal driving device 30 to raise and lower mechanically relative to the mount 10 in a first (e.g., vertical) direction A shown in FIG. 1. The horizontal driving device 30 is mounted between the mount 10 and the connecting board 60 to move the connecting board 60 relative to the mount 10 in a second (horizontal) direction B shown in FIG. 1 perpendicular to the first direction A. The rotating assembly 50 is mounted to the horizontal driving device 30, e.g., by the connecting board 60 so the rotating assembly 50 can move together with the connecting board 60 relative to the mount 10 in the second direction B. In other words, the rotating assembly 50 is mounted to the mount 10 by the horizontal driving device 30 and the connecting board 60. The suction cup assembly 80 is mounted to the rotating assembly 50 so the suction cup assembly 80 can rotate relative to the mount 10 by the rotating assembly 50 in a third direction C.

Referring to FIG. 1, the lifting device 20 includes a set of guiding grooves 112 and a set of pins 312 movably engaging the guiding grooves 112. In this exemplary embodiment, the guiding grooves 112 are defined in the mount 10 and the pins 312 are positioned on the horizontal driving device 30. When the horizontal driving device 30 moves relative to the mount 10 in the first direction A, the pins 312 move in the guiding grooves 112. It is understood that the guiding grooves 112 may be positioned on either the mount 10 or the horizontal driving device 30, and the pins 312 may be positioned on the other one of the mount 10 and the horizontal driving device 30 opposite the guiding grooves 112.

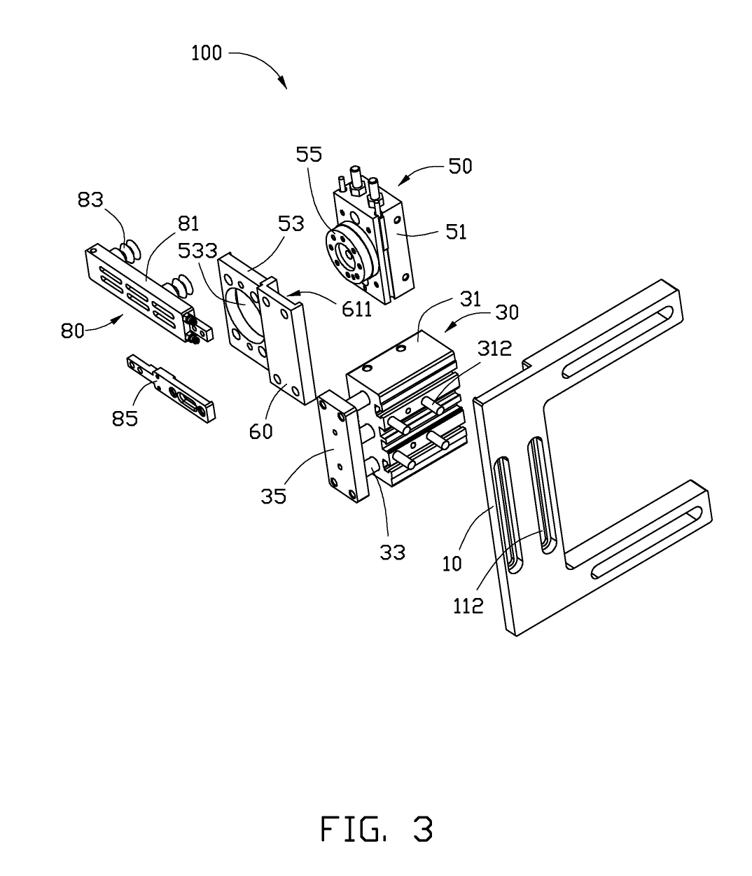

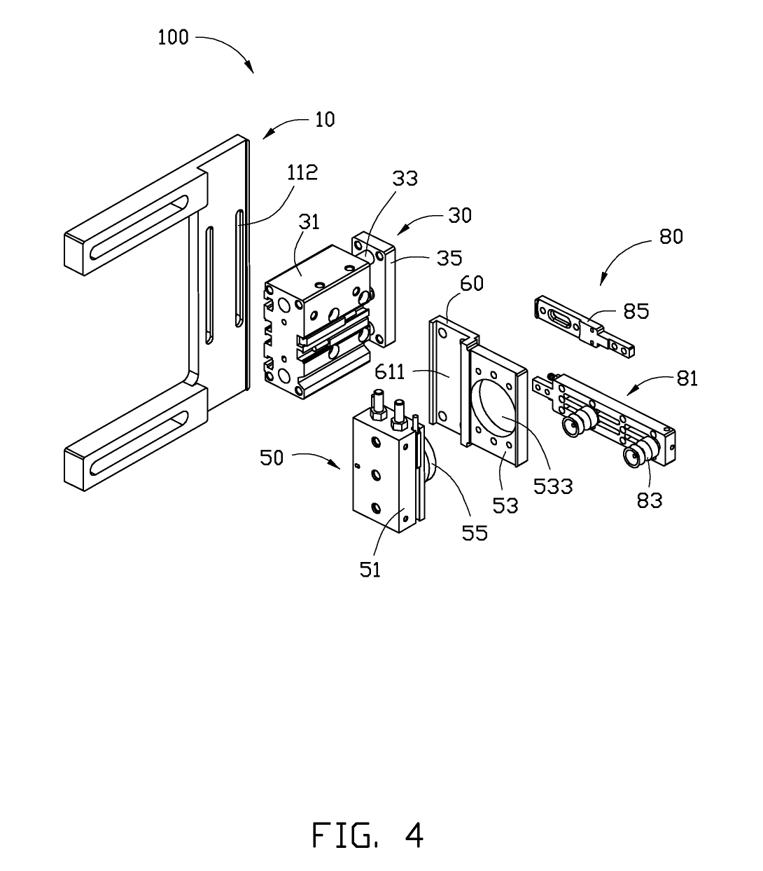

Also referring to FIGS. 3 and 4, the horizontal driving device 30 includes a cylinder 31 and a mounting board 35 movably mounted in the cylinder 31 in the second direction B, by a number of pistons 33 that movably mounted in the cylinder 31. The mounting board 35 retains the connecting board 60 to the horizontal driving device 30 so when the mounting board 35 moves relative to the cylinder 31, the mounting board 35 drives the connecting board 60 to move relative to the mount 10 and the horizontal driving device 30 in the second direction B. In this exemplary embodiment, the connecting board 60 defines a retaining groove 61, in which the mounting board 35 is retained so the connecting board 60 is retained to the mounting board 35.

The rotating assembly 50 is coupled between the connecting board 60 and the suction cup assembly 80 to rotate the suction cup assembly 80 relative to the connecting board 60, the horizontal driving device 30 and the mount 10. In this exemplary embodiment, the rotating assembly 50 includes a retaining element 53, a rotating element 51 rotatably engaging the retaining element 53, and a shaft 55. In this exemplary embodiment, the retaining element 53 is positioned on the connecting board 60 and the shaft 55 is mounted to the suction cup assembly 80. The shaft 55 is affixed to the rotating element 51 and rotatably engages with the retaining element 53 so the rotating element 51 can rotate around the shaft 55 relative to the retaining element 53. As the shaft 55 is mounted to the suction cup assembly 80, the suction cup assembly 80 can rotate together with the shaft 55 relative to the retaining element 53. In this exemplary embodiment, the shaft 55 is protruding from the rotating element 51 and extends into a shaft hole 533 defined in the retaining element 53, and the shaft 55 is slightly smaller than the shaft hole 533 so the shaft 55 can rotate in the shaft hole 533.

The suction cup assembly 80 includes a main body 81 and one or more suction cups 83 mounted to the main body 81. The main body 81 is mounted to the rotating element 51 by a connecting rod 85 which is mounted to the shaft 55. The suction cups 83 are for adhering or drawing the molded items to the robotic arm 100. In this exemplary embodiment, one end of the connecting rod 85 is mounted the main body 81, another end of the connecting rod 85 is mounted to the shaft 55.

Referring to FIG. 1, in use, the horizontal driving device 30 moves relative to the mount 10 by the lifting device 20, to adjust the distance between the suction cup assembly 80 and the molding machine in the first direction A. To adjust the distance between the suction cup assembly 80 and the molding machine in the second direction B, the cylinder 31 is started to drive the mounting board 35 to move relative to the cylinder 31 until the suction cup assembly 80 moves to a predetermined position. Additionally, the rotating element 51 can rotate relative to the retaining element 53 to adjust the angle between the suction cup assembly 80 and the molded item thereby making the suction cup assembly 80 aligned with the molded items.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A robotic arm for holding a molded item, the robotic arm comprising:
a mount;
a horizontal driving device;
a lifting device mounted between the mount and the horizontal driving device so the horizontal driving device can move relative to the mount in a first direction;
a connecting board mounted to the horizontal driving device;
a suction cup assembly for holding the molded item; and
a rotating assembly mounted between the connecting board and the suction cup assembly to enable the suction cup assembly rotate relative to the mount;
wherein the horizontal driving device moves the suction cup assembly relative to the mount in a second direction perpendicular to the first direction.

2. The robotic arm of claim 1, wherein the lifting device comprises a set of guiding grooves and a set of pins movably engaging the guiding grooves.

3. The robotic arm of claim 2, wherein the guiding grooves are defined in the mount and the pins are positioned on the horizontal driving device.

4. The robotic arm of claim 3, wherein when the horizontal driving device moves relative to the mount in the first direction, the pins move in the guiding grooves.

5. The robotic arm of claim 1, wherein the horizontal driving device comprises a cylinder and a mounting board movably mounted in the cylinder in the second direction.

6. The robotic arm of claim 5, wherein the mounting board retains the connecting board to the horizontal driving device so when the mounting board moves relative to the cylinder, the mounting board drives the connecting board to move relative to the mount and the horizontal driving device in the second direction.

7. The robotic arm of claim 6, wherein a retaining groove is defined in the connecting board, in which the mounting board is retained so the connecting board is retained to the mounting board.

8. The robotic arm of claim 1, wherein the rotating assembly comprises a retaining element, and a rotating element rotatably engaging the retaining element.

9. The robotic arm of claim 8, wherein the retaining element is positioned on the connecting board and the rotating element is mounted to the suction cup assembly.

10. The robotic arm of claim 9, wherein a shaft is affixed between the rotating element and the suction cup assembly, the shaft rotatably engages with the retaining element so the rotating element can rotate around the shaft relative to the retaining element.

11. The robotic arm of claim 10, wherein the shaft is protruding from the rotating element and extends into a shaft hole defined in the retaining element.

12. The robotic arm of claim 1, wherein the suction cup assembly comprises a main body and one or more suction cups mounted to the main body; the main body mounted to the rotating element.

13. The robotic arm of claim 12, wherein a connecting rod is mounted between the main body and the rotating element to retain the main body to the rotating element.

14. The robotic arm of claim 12, wherein the suction cups are for adhering the molded items to the robotic arm.

15. A robotic arm for holding a molded item, the robotic arm comprising:
a mount;
a suction cup assembly for holding the molded item; and
a rotating assembly mounted between the mount and the suction cup assembly to rotate the suction cup assembly relative to the mount.

16. The robotic arm of claim 15, wherein the rotating assembly includes a retaining element and a rotating element rotatably engaging the retaining element.

17. The robotic arm of claim 16, wherein the retaining element is positioned on the mount and the rotating element is positioned on suction cup assembly.

18. The robotic arm of claim 17, wherein a shaft is affixed between the rotating element and the suction cup assembly, the shaft rotatably engages with the retaining element so the rotating element can rotate around the shaft relative to the retaining element.

19. The robotic arm of claim 18, wherein a shaft hole is defined in the retaining element, the shaft is rotatably located in the shaft hole.

20. A robotic arm for holding a molded item, the robotic arm comprising:
a mount;
a suction cup assembly for holding the molded item; and
a rotating assembly mounted between the mount and the suction cup assembly to adjust the angle between the suction cup assembly and to the mount.
